(19) United States
(12) Patent Application Publication
(10) Pub. No.: US 2014/0036794 A1
(43) Pub. Date: Feb. 6, 2014

(54) USER EQUIPMENT ASSISTANCE INFORMATION SIGNALING IN A WIRELESS NETWORK

(71) Applicants: Ali T. Koc, Hillsboro, OR (US); Satish C. Jha, Hillsboro, OR (US); Maruti Gupta, Portland, OR (US); Sangeetha L. Bangolae, Beaverton, OR (US); Marta Martinez Tarradell, Hillsboro, OR (US); Rath Vannithamby, Portland, OR (US)

(72) Inventors: Ali T. Koc, Hillsboro, OR (US); Satish C. Jha, Hillsboro, OR (US); Maruti Gupta, Portland, OR (US); Sangeetha L. Bangolae, Beaverton, OR (US); Marta Martinez Tarradell, Hillsboro, OR (US); Rath Vannithamby, Portland, OR (US)

(21) Appl. No.: 13/728,658

(22) Filed: Dec. 27, 2012

Related U.S. Application Data
(60) Provisional application No. 61/679,627, filed on Aug. 3, 2012.

(51) Int. Cl. H04W 72/04

(52) U.S. Cl. CPC H04W 72/044
USPC 370/329

(57) ABSTRACT

Generally, this disclosure provides apparatus and methods for improved signaling of User Equipment (UE) assistance information in a wireless network. The UE device may include a processing circuit configured to generate an assistance information message including a power preference indicator (PPI) and mobility state information (MSI), the PPI and the MSI associated with the UE; a signal generation module configured to generate a Medium Access Control (MAC) layer Control Element (CE) signal, the MAC CE signal including the assistance information message; and a transmitter circuit configured to transmit the MAC CE signal to an evolved Node B (eNB) of a wireless network associated with the UE, the MAC CE signal transmitted on an uplink shared channel (UL-SCH). The assistance information message may also be generated as a Radio Resource Control (RRC) message and transmitted on an uplink dedicated control channel (UL-DCCH).

### CROSS-REFERENCE TO RELATED APPLICATIONS

The present patent application is related to and claims priority to U.S. Provisional Patent Application Ser. No. 61/679,627, filed Aug. 3, 2012, the content of which is incorporated herein by reference in its entirety.

### FIELD

The present disclosure relates to wireless networks, and more particularly, to apparatus and methods for improved signaling of User Equipment (UE) assistance information in a wireless network.

### BACKGROUND

In wireless networks, for example Long Term Evolution (LTE) and LTE-Advanced (LTE-A) networks, mobile communication devices, also referred to as User Equipment or UEs, operate within cellular coverage regions or cells. One or more base stations, also known as evolved Node B (eNB) transceivers, are typically associated with each cell. The eNBs communicate with and manage the UEs by monitoring UE status and adjusting configuration options and parameters associated with the UEs and/or the network to increase operational efficiency.

As network traffic increases, new system enhancements are being implemented in the LTE/LTE-A networks. Along with these enhancements, new forms of UE status information and operational preference indicators may need to be transmitted between the UE and the eNB. This additional information transfer, however, may have an adverse impact on signaling overhead and/or consume additional bandwidth, which is a limited resource.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates a message structure associated with one exemplary embodiment consistent with the present disclosure;

FIG. 4 illustrates a message flow diagram of an exemplary embodiment consistent with the present disclosure;

FIG. 5 illustrates a data structure associated with one exemplary embodiment consistent with the present disclosure;

FIG. 6 illustrates a data structure associated with another exemplary embodiment consistent with the present disclosure;

FIG. 7 illustrates a data structure associated with another exemplary embodiment consistent with the present disclosure;

FIG. 8 illustrates a data structure associated with another exemplary embodiment consistent with the present disclosure;

FIG. 9 illustrates a data structure associated with another exemplary embodiment consistent with the present disclosure;

FIG. 10 illustrates a flowchart of operations of an exemplary embodiment consistent with the present disclosure; and

FIG. 11 illustrates a platform of one exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides apparatus and methods for improved signaling of User Equipment (UE) assistance information in a wireless network, for example an LTE or LTE-A network. The UE (e.g., the mobile device) may be configured to generate a power preference indicator (PPI). The PPI may be associated with a tradeoff between UE power consumption and latency. The UE may also be configured to generate mobility state information (MSI). The MSI may be associated with a handover rate when the UE is in a connected state and a cell re-selection rate when the UE is in an idle state. The PPI and/or the MSI may be transmitted to an evolved Node B (eNB) in the form of a UE assistance information message that enables the network to configure Radio Resource Control (RRC) parameters to improve system/network performance.

In some embodiments, UE assistance information message may be transmitted as a Medium Access Control (MAC) layer Control Element (CE) signal on an uplink shared channel (UL-SCH). In some embodiments, UE assistance information message may be transmitted as a Radio Resource Control (RRC) message on an uplink dedicated control channel (UL-DCCH).

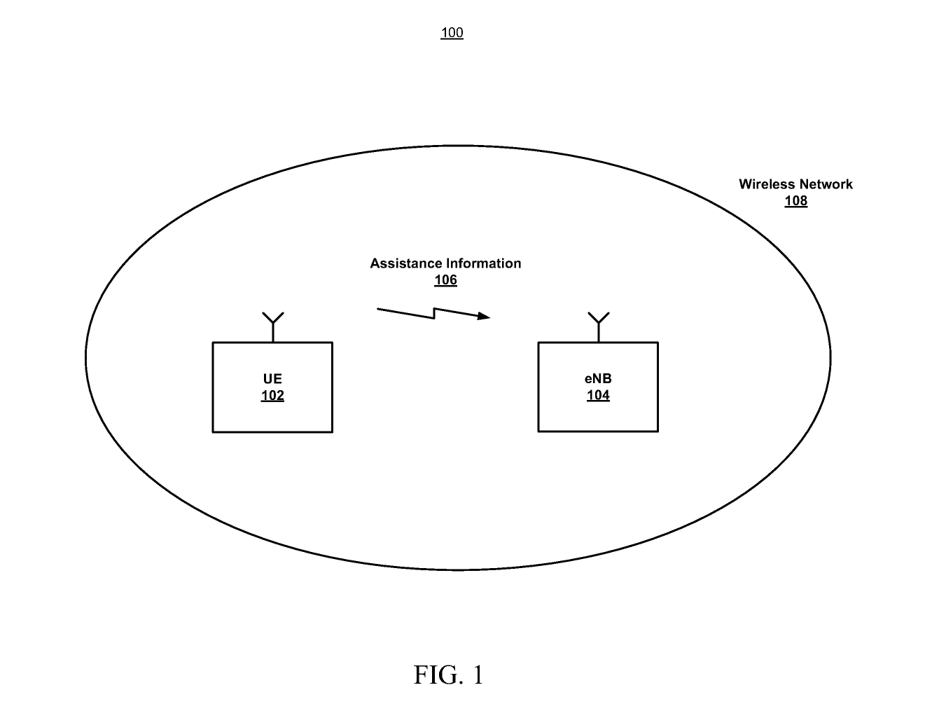

FIG. 1 illustrates a top level system diagram 100 of one exemplary embodiment consistent with the present disclosure. A wireless network 108 is shown to include an eNB 104 and a UE 102. The eNB 104 may be serving the cell coverage area in which the UE 102 is operating. The UE 102 may be configured to transmit an assistance information message 106 to the eNB 104, as will be explained in greater detail below. The assistance information may include a PPI and an MSI associated with the UE 102 that enables the eNB 104 to configure RRC parameters to improve system/network performance. In some embodiments, the assistance information may further include a measurement or estimation of average packet inter-arrival time, background traffic versus active traffic, battery power level and/or any other suitable information.

The wireless network 108 may comply with, or otherwise be compatible with, the Third Generation Partnership Project (3GPP) Long Term Evolution (LTE) and/or LTE-Advanced (LTE-A) based wireless network standard, including current, previous and future versions of that standard. While this is a simplified example, for illustration purposes, it will be appreciated that in practice the network may comprise any number of eNBs and UEs deployed in any configuration.

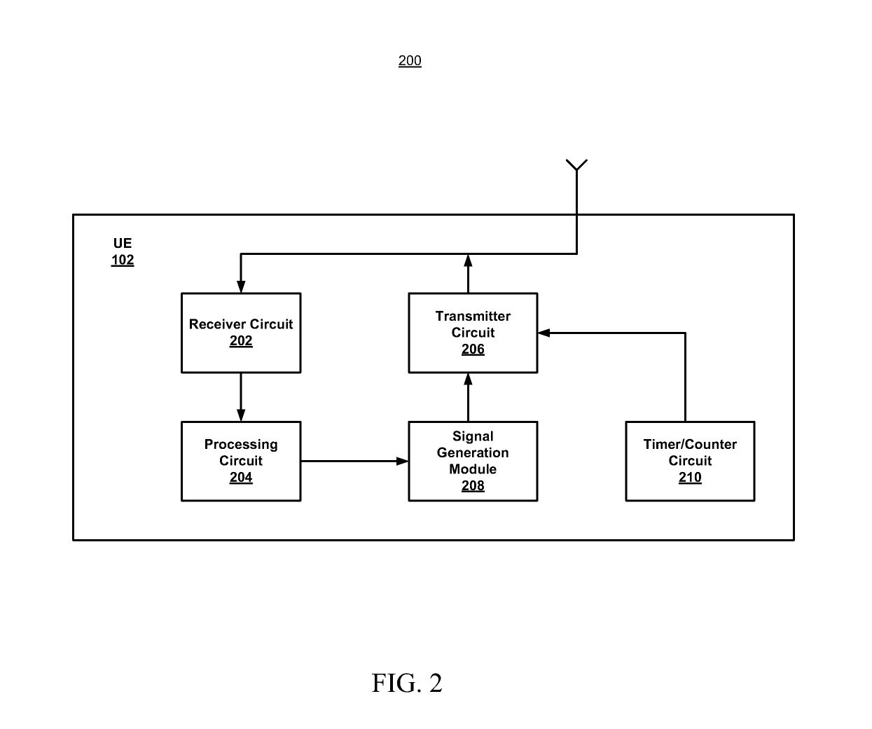

FIG. 2 illustrates a block diagram 200 of one exemplary embodiment consistent with the present disclosure. UE 102 is shown to comprise receiver circuit 202, processing circuit 204, transmitter circuit 206, signal generation module 208 and timer/counter circuit 210.

Processing circuit 204 may be configured to determine a power preference state for the UE 102. The power preference state may correspond to any of a range of values from a relatively low power consumption state to a relatively high power consumption state. The lower power preference state may offer the advantage of increased battery life, but this may come at the expense of certain degradations in device performance, such as, for example, increased communication latency. Conversely, a higher power preference state may provide increased device performance in exchange for a reduced battery life. Processing circuit 204 may generate a PPI to indicate the desired power preference state for the UE 102. In some embodiments, the PPI may represent or correspond to the actual desired power preference state or it may indicate the desire for a default state. In other embodiments, the PPI may represent a change in state (e.g., up or down) from the current state towards either end of the range of states.

Processing circuit 204 may also be configured to determine a mobility state of the UE 102. In some embodiments, the mobility state may represent the number of handovers of the UE per unit of time (e.g., a handover rate) during a time period in which the UE is in a connected state. In some embodiments, the mobility state may represent the number of cell re-selections of the UE per unit of time (e.g., a cell re-selection rate) during a time period in which the UE is in an idle state. An MSI may be generated to represent or quantify the mobility state within a range of values from a relatively low mobility (or no mobility) to a relatively high mobility. Processing circuit 204 may further be configured to generate an assistance information message (or information element) comprising the PPI and the MSI.

In some embodiments, signal generation module 208 may be configured to generate a MAC layer CE signal based on the assistance information message, as will be described in greater detail below. In these embodiments, transmitter circuit 206 may be configured to transmit the signal to an eNB 104 on a UL-SCH.

In some embodiments, signal generation module 208 may be configured to generate an RRC message based on the assistance information element, as will be described in greater detail below. In these embodiments, transmitter circuit 206 may be configured to transmit the RRC message to an eNB 104 on a UL-DCCH.

Receiver circuit 202 may be configured to receive a message from the eNB 104 in response to the transmission of the assistance information. The response may be an RRCConnectionReconfiguration message that includes updated discontinuous reception (DRX) configuration parameters that may be based on the PPI and MSI of the UE 102. The updated DRX parameters may enable more efficient UE operation such as increased conservation of battery power with affecting latency.

In some embodiments, the transmission of the assistance information to the eNB 104 may be repeated or re-transmitted until a response is received from the eNB. Timer/counter circuit 210 may be configured to impose a minimum time period or delay between consecutive re-transmissions of the assistance message. This minimum time period between re-transmissions may be set to a threshold value to reduce signaling overhead and increase bandwidth efficiency between the UE 102 and the eNB 104. In some embodiments, separate timers may be used for re-transmission of the PPI and re-transmission of the MSI. The timer/counter circuit 210 may further be configured to limit the total number of such re-transmissions since the eNB may choose not to respond to the assistance information. The timer delay threshold and maximum re-transmission threshold values may be set by the eNB and provided to the UE. In some embodiments, these values may be defined as an integer value common to each cell, an integer value defined for each RRC connection or an integer value defined for each assistance information trigger event (e.g., a UE transition out of an idle state or a change in UE power preference settings).

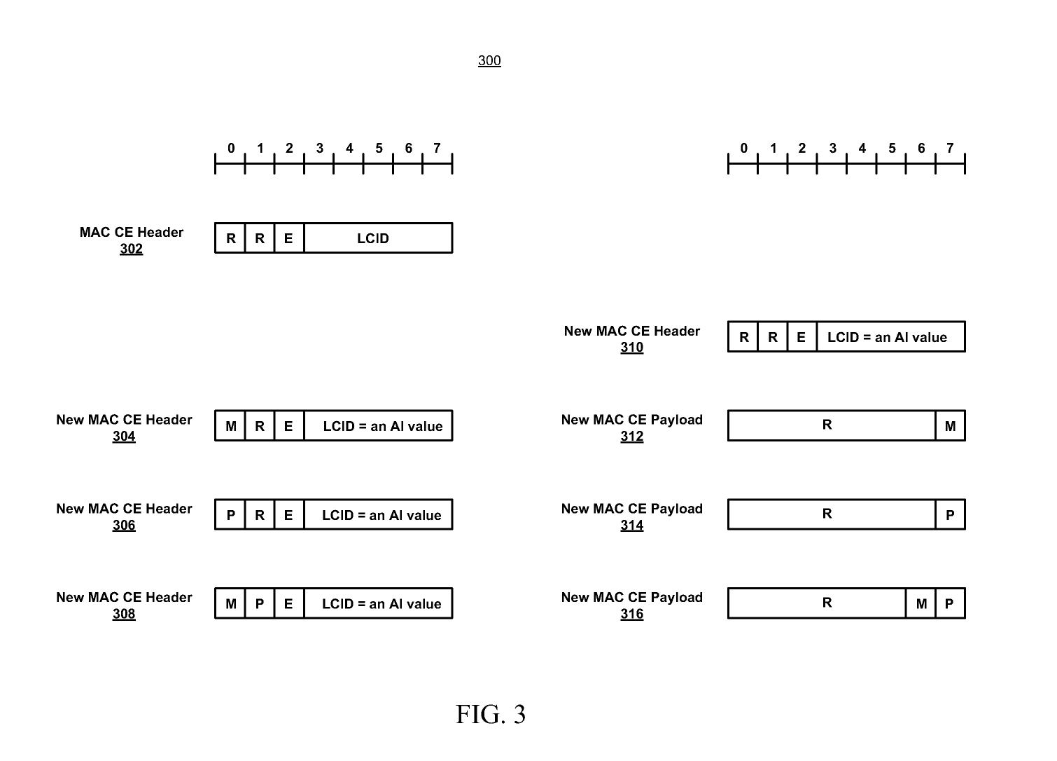

FIG. 3 illustrates a message structure 300 associated with one exemplary embodiment consistent with the present disclosure. A MAC layer CE signal may comprise a MAC CE header and an optional payload. An existing MAC CE header format 302 is shown which includes a logic channel identifier (LCID) in bits 3-7. Bits 0 and 1 are reserved and bit 2 is an extension bit used to indicate the presence of an extended length header (using additional octets). LCIDs in the range from 01011 to 11000, inclusive, are reserved, so one or more of these values may be employed in a new MAC CE header format to indicate that the MAC CE signal is used to convey assistance information (AI). For example, an LCID value of 10111 may indicate that the new MAC CE header 304 includes an MSI in bit 0. As another example, an LCID value of 11000 may indicate that the new MAC CE header 306 includes a PPI in bit 0. As a further example, another selected LCID value from the reserved range may indicate that the new MAC CE header 308 includes both an MSI in bit 0 and a PPI in bit 1. As yet a further example, another selected LCID value from the reserved range may indicate that the new MAC CE header 310 is accompanied by a single octet payload 312, 314 or 316. The payloads may include an MSI bit, a PPI bit or both. In some embodiments, the payload may allow the PPI and/or MSI to be represented by 2 or more bits (not shown) to provide additional levels within their respective range of values.

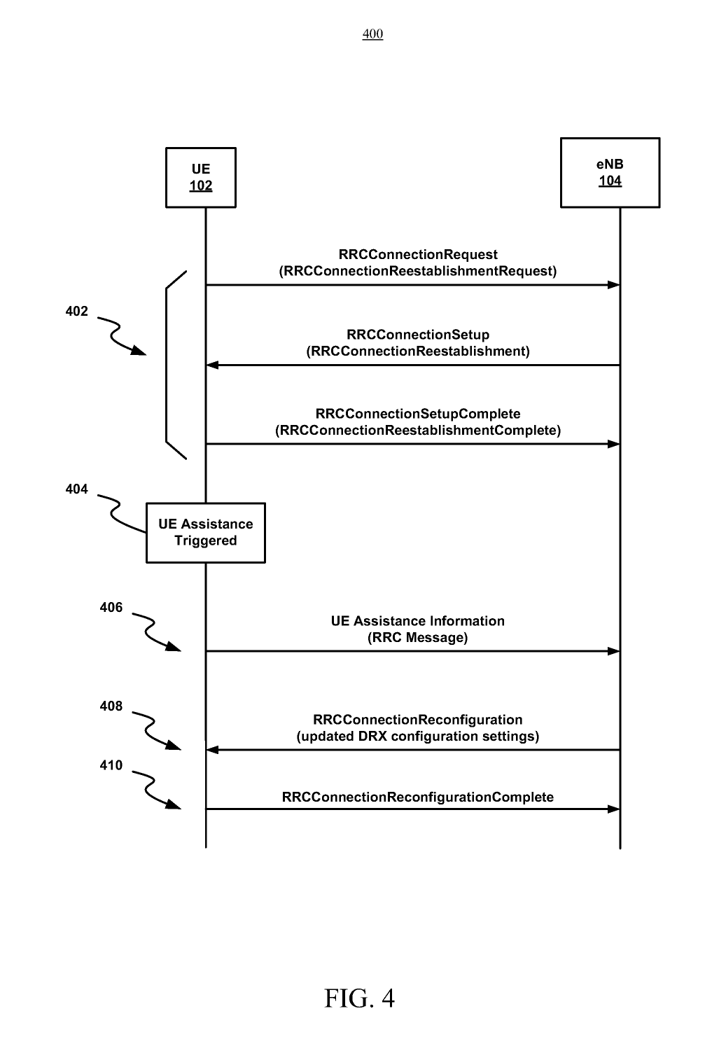

FIG. 4 illustrates a message flow diagram 400 of an exemplary embodiment consistent with the present disclosure. The message flow diagram 400 provides an example of UE assistance information handling between UE 102 and eNB 104 through RRC message exchanges. The RRC message formats will be described in greater detail below. An initial connection 402 is established between the UE and eNB by sending an RRCConnectionRequest (or RCConnectionReestablishmentRequest) from the UE 102. The eNB then responds with an RRCConnectionSetup (or RRCConnectionReestablishment) message and the UE acknowledges setup completion with an RRCConnectionSetupComplete (or RRCConnectionReestablishmentComplete) message. At some later point in time, a UE assistance transmission is triggered 404. This may result, for example, from a UE transition out of an idle state to a connected state or by a change in UE power preference settings. The UE assistance information, in the form of an RRC message 406, is sent to the eNB. The eNB may respond with an RRCConnectionReconfiguration message that provides updated DRX configuration setting to the UE and the UE may acknowledge with an RRCConnectionReconfigurationComplete message.

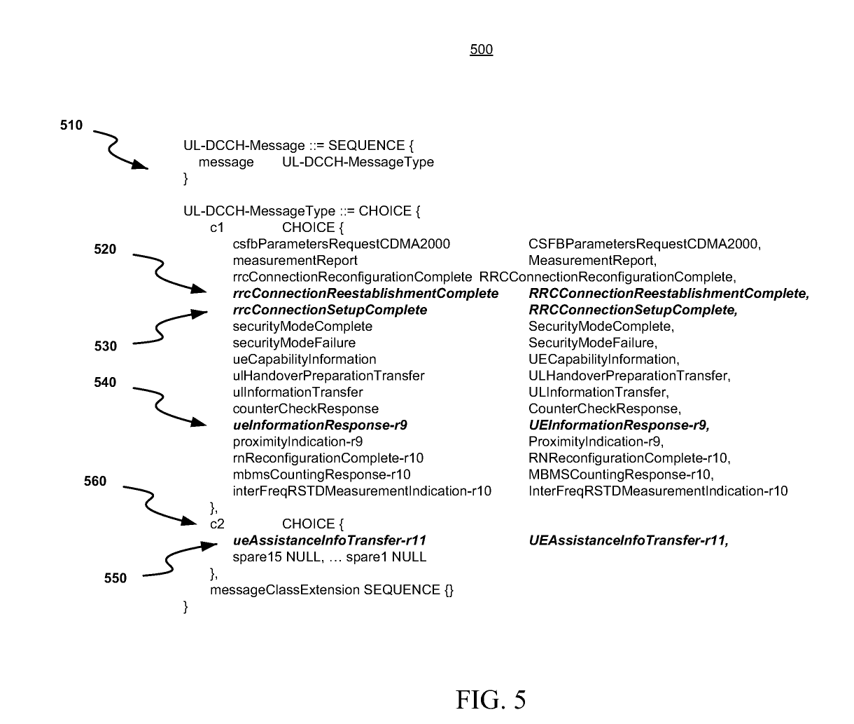

FIGS. 5 through 9 illustrate data structures and/or message fields that may comply with, or otherwise be compatible with, the 3GPP LTE and/or LTE-A based wireless network standard, including current, previous and future versions of that standard.

FIG. 5 illustrates a data structure 500 associated with one exemplary embodiment consistent with the present disclosure. The UE 102 may send the assistance information to the eNB 104 as an inclusion in any one of a number of different types of RRC messages which are transmitted on a UL-DCCH channel which conforms to the UL-DCCH message type 510. In some embodiments, the available existing RRC message types comprise RRCConnectionReestablishmentComplete 520, RRCConnectionSetupComplete 530 and UEInformationResponse-r9 540. In some embodiments, a new RRC message type, UEAssistanceInfoTransfer-r11 550, may be provided. The UEAssistanceInfoTransfer-r11 550 message may be provided as an additional choice information element, for example c2 560, in the UL-DCCH message structure.

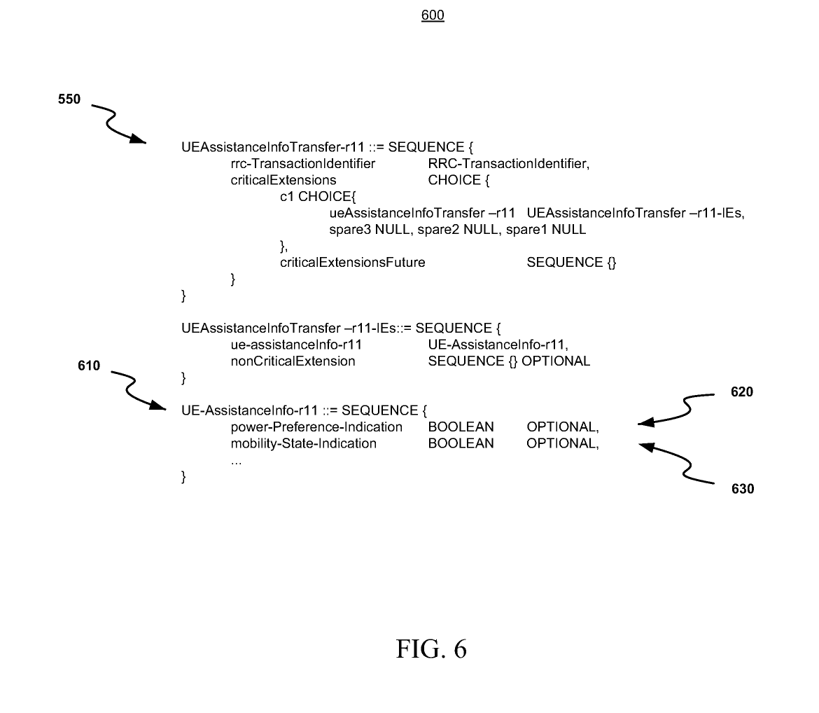

FIG. 6 illustrates a data structure 600 associated with another exemplary embodiment consistent with the present disclosure. The new UEAssistanceInfoTransfer-r11 550 message type is shown to include a UE-AssistanceInfo-r11 information element 610 which in turn comprises a power-Preference-Indication information element 620 and a mobility-State-Indication information element 630. The UEAssistanceInfoTransfer-r11 550 message may use signaling radio bearer 1 and Radio Link Control (RLC) Acknowledge Mode (AM) mode over logical channel DCCH.

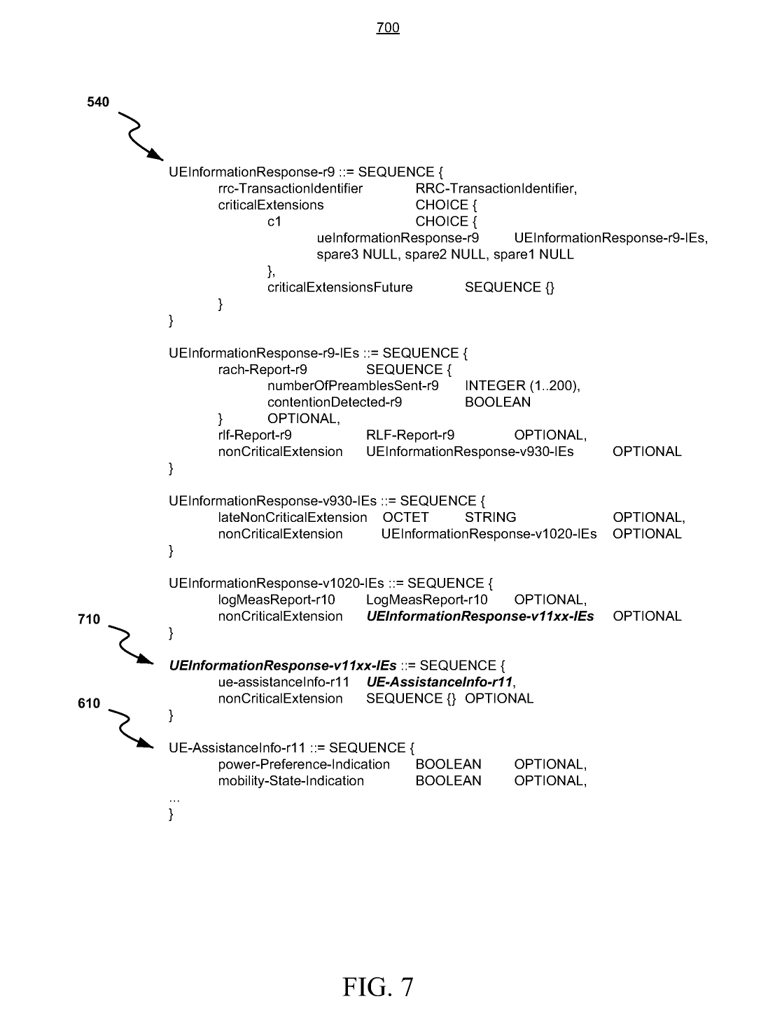

FIG. 7 illustrates a data structure 700 associated with another exemplary embodiment consistent with the present disclosure. The UEInformationResponse-r9 540 message type is shown to be modified to include the new UEInformationResponse-v11xx-IEs information element 710 which in turn includes the previously described UE-AssistanceInfo-r11 information element 610.

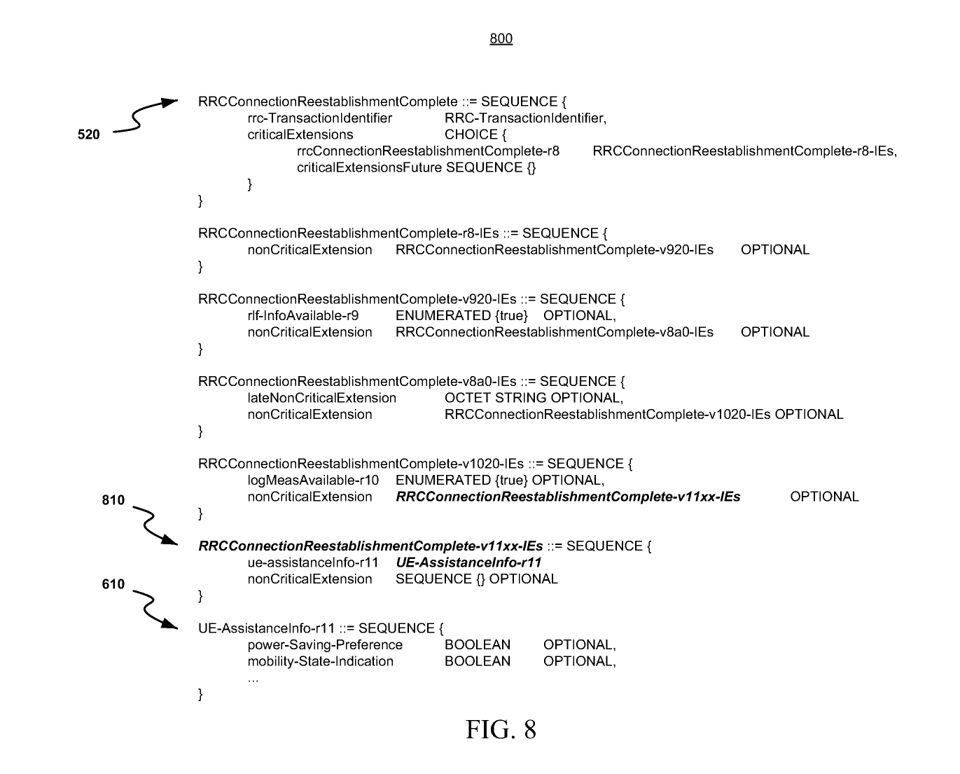

FIG. 8 illustrates a data structure 800 associated with another exemplary embodiment consistent with the present disclosure. The RRCConnectionReestablishmentComplete 520 message type is shown to be modified to include the new RRCConnectionReestablishmentComplete-v11xx-IEs information element 810 which in turn includes the previously described UE-AssistanceInfo-r11 information element 610. This may provide a more efficient signaling mechanism for transmitting assistance information from the UE 102 to the eNB 104.

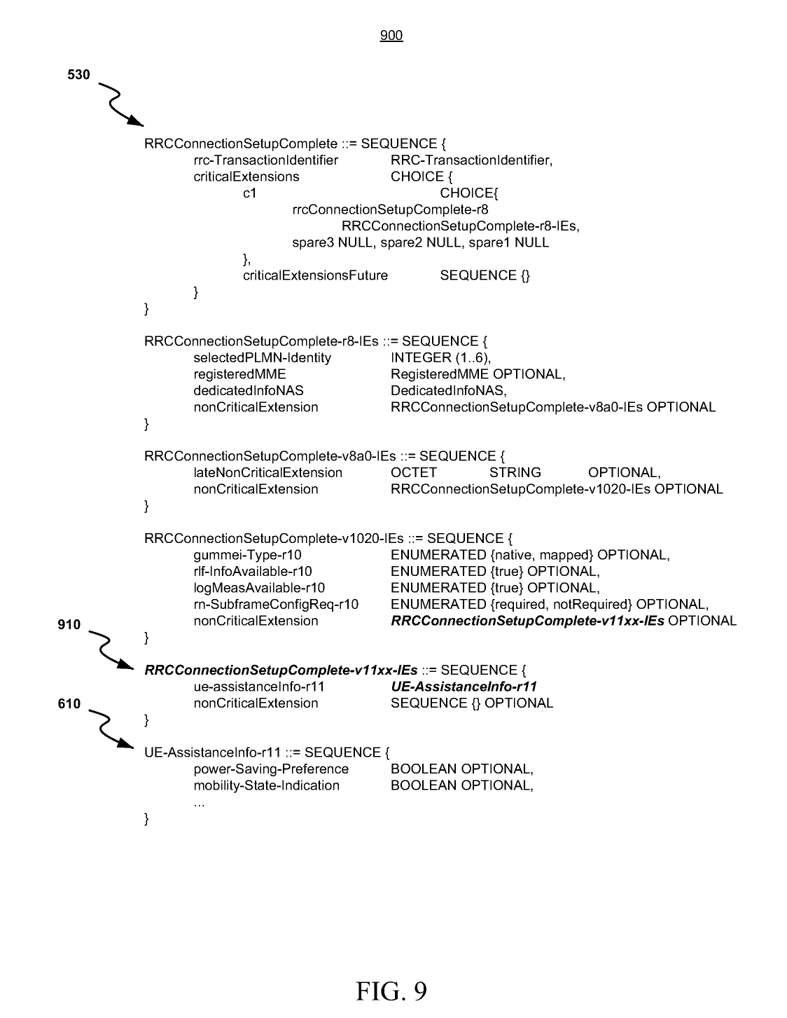

FIG. 9 illustrates a data structure 900 associated with another exemplary embodiment consistent with the present disclosure. The RRCConnectionSetupComplete 530 message type is shown to be modified to include the new RRCConnectionSetupComplete-v11xx-IEs information element 910 which in turn includes the previously described UE-AssistanceInfo-r11 information element 610. This may provide a more efficient signaling mechanism for transmitting assistance information from the UE 102 to the eNB 104.

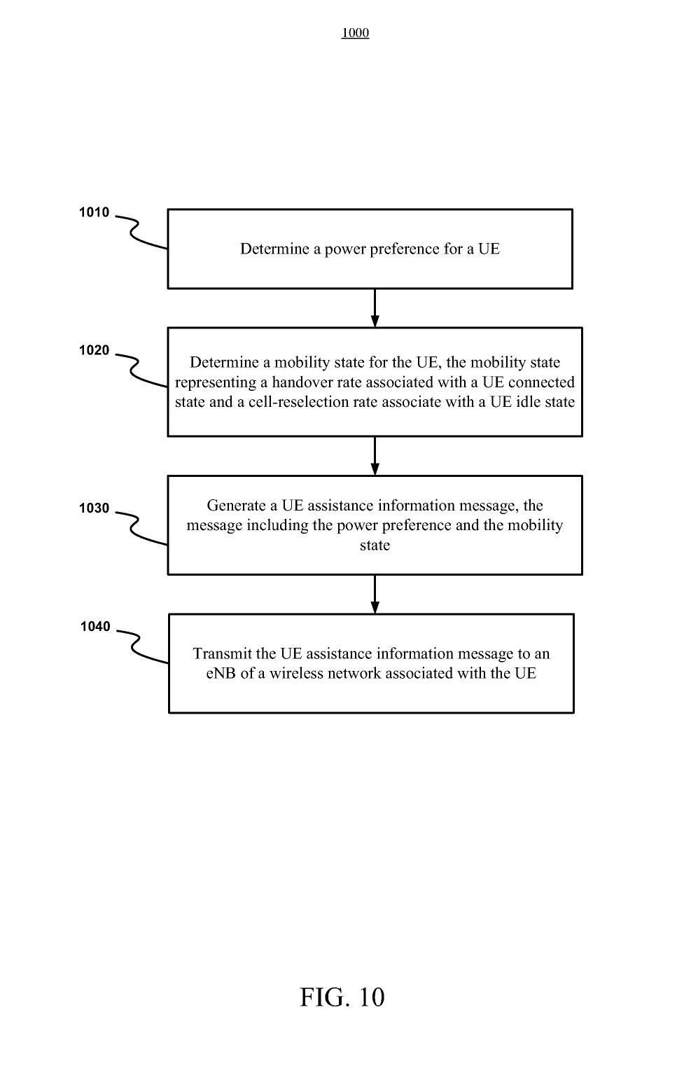

FIG. 10 illustrates a flowchart of operations 1000 of an exemplary embodiment consistent with the present disclosure. At operation 1010, a power preference is determined for a UE. At operation 1020, a mobility state is determined for the UE. The mobility state represents a handover rate associated with a UE connected state and a cell-reselection rate associate with a UE idle state. At operation 1030, a UE assistance information message is generated. The message includes the power preference and the mobility state. At operation 1040, the UE assistance information message is transmitted to an eNB of a wireless network associated with the UE. The message may be transmitted as a MAC CE signal on a UL-SCH channel or as an RRC message on a UL-DCCH channel.

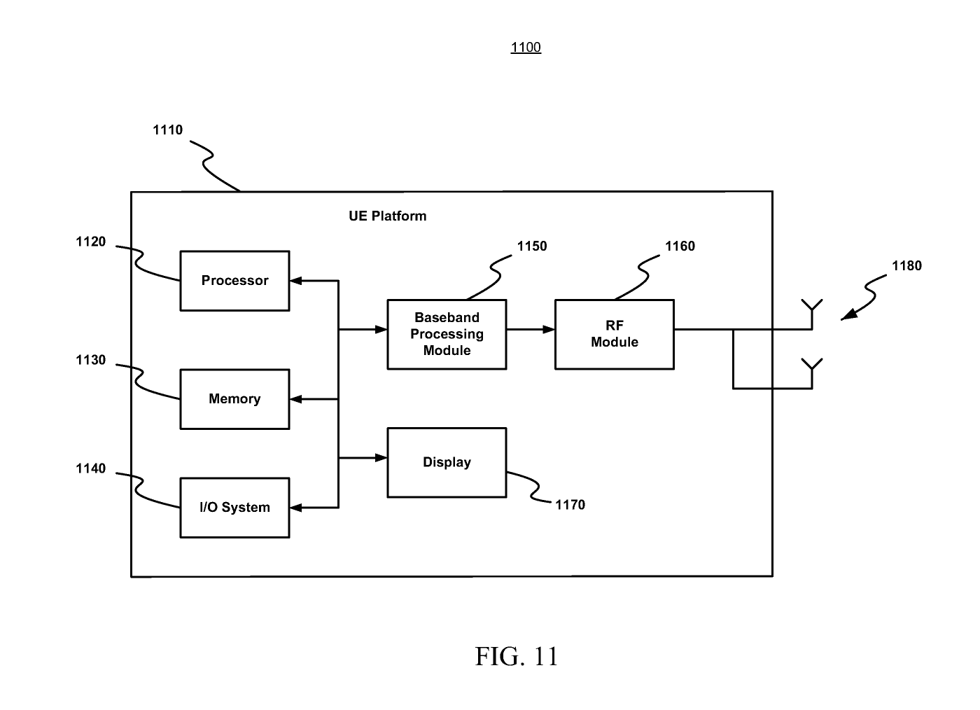

FIG. 11 illustrates a platform configuration 1100 of one exemplary embodiment consistent with the present disclosure. The platform 1110 may be a mobile communication device, such as, for example, a UE device (smartphone), a tablet, a laptop computing device or any other device configured to transmit or receive wireless signals. In some embodiments, platform 1110 may comprise a processor 1120, memory 1130, an input/output (I/O) system 1140, a display/keyboard or other type of user interface (UI) 1170 such as, for example, a touchscreen. Platform 1110 may further comprise a baseband processing module 1150 and an RF processing module 1160 as well as one or more antennas 1180 which may form part of a Multiple Input Multiple Output (MIMO) antenna system. Any number of platforms 1100 may transmit or receive signals through RF module 1160 and antennas 1180 over a wireless network which may be an LTE or LTE-A wireless network.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides apparatus and methods for improved signaling of User Equipment (UE) assistance information in a wireless network.

According to one aspect there is provided a UE. The UE may include a processing circuit configured to generate an assistance information message including a PPI and an MSI, the PPI and the MSI associated with the UE. The UE of this example may also include a signal generation module configured to generate a MAC layer CE signal, the MAC CE signal including the assistance information message. The UE of this example may further include a transmitter circuit configured to transmit the MAC CE signal to an eNB of a wireless network associated with the UE, the MAC CE signal transmitted on a UL-SCH.

Another example UE includes the forgoing components and further includes a receiver circuit configured to receive an RRCConnectionReconfiguration message from the eNB in response to the MAC CE signal transmission, the RRCConnectionReconfiguration message including DRX configuration parameters.

Another example UE includes the forgoing components and further includes a timer circuit configured to delay transmission of the MAC CE signal such that the time period between consecutive transmissions of the MAC CE signal exceeds a minimum elapsed time threshold.

Another example UE includes the forgoing components and further includes a counter circuit configured to limit the number of consecutive transmissions of the MAC CE signal to a maximum threshold value, the counter circuit reset in response to receiving a reply from the eNB, the reply in response to the transmitted MAC CE signal.

Another example UE includes the forgoing components and the PPI represents a UE power preference state, the state being a lower power configuration state or a lower latency configuration state.

Another example UE includes the forgoing components and the PPI represents a UE power preference state change, the state change between a lower power configuration state and a lower latency configuration state.

Another example UE includes the forgoing components and the MSI represents a handover rate associated with a UE connected state and a cell-reselection rate associated with a UE idle state.

Another example UE includes the forgoing components and further includes memory coupled to the processing circuit, an I/O system coupled to the processing circuit, and a touchscreen display coupled to the I/O system.

According to another aspect there is provided a UE. The UE may include a processing circuit configured to generate a UE assistance information element including a PPI and an MSI, the PPI and the MSI associated with the UE. The UE of this example may also include a signal generation module configured to generate an RRC message, the RRC message including the UE assistance information element. The UE of this example may further include a transmitter circuit configured to transmit the RRC message to an eNB of a wireless network associated with the UE, the RRC message transmitted on a UL-DCCH.

Another example UE includes the forgoing components and further includes a receiver circuit configured to receive an RRCConnectionReconfiguration message from the eNB in response to the RRC message transmission, the RRCConnectionReconfiguration message including DRX configuration parameters.

Another example UE includes the forgoing components and the RRC message is an rrcConnectionReestablishmentComplete message, an rrcConnectionSetupComplete message and/or a ueInformationResponse-r9 message.

Another example UE includes the forgoing components and the RRC message is a UEAssistanceInfoTransfer-r11 message.

Another example UE includes the forgoing components and further includes a timer circuit configured to delay transmission of the RRC message such that the time period between consecutive transmissions of the RRC message exceeds a minimum elapsed time threshold.

Another example UE includes the forgoing components and further includes a counter circuit configured to limit the number of consecutive transmissions of the RRC message to a maximum threshold value, the counter circuit reset in response to receiving a reply from the eNB, the reply in response to the transmitted RRC message.

Another example UE includes the forgoing components and the PPI represents a UE power preference state, the state being a lower power configuration state or a lower latency configuration state.

Another example UE includes the forgoing components and the PPI represents a UE power preference state change, the state change between a lower power configuration state and a lower latency configuration state.

Another example UE includes the forgoing components and the MSI represents a handover rate associated with a UE connected state and a cell-reselection rate associated with a UE idle state.

Another example UE includes the forgoing components and further includes memory coupled to the processing circuit, an I/O system coupled to the processing circuit, and a touchscreen display coupled to the I/O system.

According to another aspect there is provided a method. The method may include determining a power preference for a UE. The method of this example may also include determining a mobility state for the UE, the mobility state representing a handover rate associated with a UE connected state and a cell-reselection rate associated with a UE idle state. The method of this example may further include generating a UE assistance information message, the message including the power preference and the mobility state. The method of this example may further include transmitting the UE assistance information message to an eNB of a wireless network associated with the UE.

Another example method includes the forgoing operations and further includes transmitting the UE assistance information message as a MAC layer CE signal on a UL-SCH.

Another example method includes the forgoing operations and further includes transmitting the UE assistance information message as an RRC message on a UL-DCCH.

Another example method includes the forgoing operations and the RRC message is an rccConnectionReestablishmentComplete message, an rrcConnectionSetupComplete message, a ueInformationResponse-r9 message, and/or a UEAssistanceInfoTransfer-r11 message.

Another example method includes the forgoing operations and further includes receiving an RRCConnectionReconfiguration message from the eNB in response to the UE assistance information message transmission, the RRCConnectionReconfiguration message including DRX configuration parameters.

Another example method includes the forgoing operations and the power preference is a lower power configuration state or a lower latency configuration state.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1-24. (canceled)

25. User Equipment (UE) comprising:
a signal generation module to generate a UE assistance information element comprising a power preference indicator (PPI) associated with said UE, said signal generation module further to generate a Radio Resource Control (RRC) message, said RRC message comprising said UE assistance information element, said signal generation module further to communicate said RRC message on an uplink dedicated control channel (UL-DCCH); and
a transmitter circuit to transmit said RRC message to an evolved Node B (eNB) of a wireless network associated with said UE.

26. The UE of claim 25, further comprising a receiver circuit to receive an RRCConnectionReconfiguration message from said eNB in response to said RRC message transmission, said RRCConnectionReconfiguration message comprising discontinuous reception (DRX) configuration parameters.

27. The UE of claim 25, further comprising a timer circuit to delay transmission of said RRC message such that the time period between consecutive transmissions of said RRC message exceeds a minimum elapsed time threshold.

28. The UE of claim 25, wherein said PPI represents a UE power preference state, said state selected from the group consisting of a lower power configuration state and a higher power configuration state.

29. The UE of claim 25, wherein said PPI represents a UE power preference state change, said state change between a lower power configuration state and a higher power configuration state.

30. The UE of claim 25, wherein said UE assistance information element further comprises mobility state information (MSI), said MSI providing a handover rate associated with a UE connected state and a cell-reselection rate associated with a UE idle state.

31. The UE of claim 25, further comprising a counter circuit to limit the number of consecutive transmissions of said RRC message to a maximum threshold value, said counter circuit reset in response to receiving a reply from said eNB, said reply in response to said transmitted RRC message.

32. The UE of claim 25, further comprising memory coupled to a processing circuit to host said signal generation module, an input/output (I/O) system coupled to said processing circuit, and a touchscreen display coupled to said I/O system.

33. A method comprising:
determining a power preference for a User Equipment (UE);
generating a UE assistance information message, said message comprising said power preference; and
transmitting said UE assistance information message to an evolved Node B (eNB) of a wireless network associated with said UE.

34. The method of claim 33, further comprising communicating said UE assistance information message as a Radio Resource Control (RRC) message on an uplink dedicated control channel (UL-DCCH).

35. The method of claim 33, further comprising receiving an RRCConnectionReconfiguration message from said eNB in response to said UE assistance information message transmission, said RRCConnectionReconfiguration message comprising discontinuous reception (DRX) configuration parameters.

36. The method of claim 33, further comprising delaying transmission of said RRC message such that the time period between consecutive transmissions of said RRC message exceeds a minimum elapsed time threshold.

37. The method of claim 33, wherein said power preference is selected from the group consisting of a lower power configuration state and a higher power configuration state.

38. An enhanced Node B (eNB) comprising:
a receiver circuit to receive an RRC message from a UE on a wireless network;
a signal processing module to extract a UE assistance information element from said RRC message, said RRC message communicated to said signal processing module on a UL-DCCH; and
said signal processing circuit further to extract a PPI associated with said UE from said UE assistance information element.

39. The eNB of claim 38, further comprising a transmitter circuit to transmit an RRCConnectionReconfiguration message to said UE in response to said RRC message reception, said RRCConnectionReconfiguration message comprising discontinuous reception (DRX) configuration parameters.

40. The eNB of claim 38, wherein said PPI represents a UE power preference state, said state selected from the group consisting of a lower power configuration state and a higher power configuration state.

41. A computer-readable storage medium having instructions stored thereon which when executed by a processor result in the following operations comprising:
determining a power preference for a User Equipment (UE);
generating a UE assistance information message, said message comprising said power preference; and
transmitting said UE assistance information message to an evolved Node B (eNB) of a wireless network associated with said UE.

42. The computer-readable storage medium of claim 41, further comprising the operation of communicating said UE assistance information message as a Radio Resource Control (RRC) message on an uplink dedicated control channel (UL-DCCH).

43. The computer-readable storage medium of claim 41, further comprising the operation of receiving an RRCConnectionReconfiguration message from said eNB in response to said UE assistance information message transmission, said RRCConnectionReconfiguration message comprising discontinuous reception (DRX) configuration parameters.

44. The computer-readable storage medium of claim 41, further comprising the operation of delaying transmission of said RRC message such that the time period between consecutive transmissions of said RRC message exceeds a minimum elapsed time threshold.

45. The computer-readable storage medium of claim 41, wherein said power preference is selected from the group consisting of a lower power configuration state and a higher power configuration state.
